(19) United States
(12) Patent Application Publication
(10) Pub. No.: US 2025/0223862 A1
(43) Pub. Date: Jul. 10, 2025

(54) METHOD FOR OPERATING A FLAP ASSEMBLY OF A MOTOR VEHICLE

(71) Applicant: Brose Fahrzeugteile SE & Co. Kommanditgesellschaft, Bamberg, Bamberg (DE)

(72) Inventors: Philipp Link, Hallstadt (DE); Johannes Merk, Hohen Neuendorf (DE); Denis Schmidt, Berlin (DE); Ridvan Yalcin, Ulm (DE); Sebastian Hermeling, Bamberg (DE)

(21) Appl. No.: 18/688,137

(22) PCT Filed: Aug. 29, 2022
(86) PCT No.: PCT/EP2022/073897

§ 371 Date: Oct. 7, 2024

(30) Foreign Application Priority Data
Sep. 3, 2021 (DE) 10 2021 122 890.5

(51) Int. Cl. E05F 15/75; E05B 81/76

(52) U.S. Cl. CPC E05F 15/75; E05B 81/77; E05Y 2400/822; E05Y 2400/86; E05Y 2900/531

(57) ABSTRACT

A method for operating a door arrangement of a motor vehicle with a door which can be adjusted via a door kinematic system, the door arrangement having a control arrangement for actuating a drive arrangement with at least one electric drive and a sensor arrangement for detecting operator actions, a plurality of predefined operating actions being provided to trigger an actuating function of the door arrangement, the output of an operator information item which contains an indication to the operator of at least one of the predefined operator actions being carried out being caused by of the control arrangement. The predefined operator actions are assigned respective boundary conditions to be met, that at least one of the predefined operator actions is selected as recommended operator action by the control arrangement based on the assignment and the given boundary conditions.

### CROSS-REFERENCE TO RELATED APPLICATIONS

This application is a national stage application under 35 U.S.C. 371 of International Patent Application Serial No. PCT/EP2022/073897, entitled “Method for Operating a Flap Assembly of a Motor Vehicle,” filed Aug. 29, 2022, which claims priority from German Patent Application No. DE 10 2021 122 890.5, filed Sep. 3, 2021, the disclosure of which is incorporated herein by reference.

### FIELD OF THE TECHNOLOGY

Various embodiments relate to methods for operating a door arrangement of a motor vehicle and to a motor vehicle.

### BACKGROUND

In the case of the known method (DE 10 2017 129 151 A1), from which some embodiments proceed, the operation of the door arrangement by way of a predefined operator action is provided. The operator action is, for example, a predetermined foot movement of the operator. To this end, operator movements are detected by means of a control arrangement via a sensor arrangement, and are classified as a valid operator gesture or as an invalid operator gesture. If it is classified as a valid operator gesture, an actuation of a drive arrangement occurs for the provision of an actuating function, in particular motorized opening of the associated door.

### SUMMARY

The door arrangement in question is provided for an adjustable door of a motor vehicle. The door can be any closing element of a motor vehicle. This includes tailgates, trunk lids, front hoods, in particular engine hoods, doors, in particular side or rear doors, or the like. The door can be arranged pivotably or longitudinally displaceably on the motor vehicle body.

In many cases, a plurality of operator actions are possible in order to trigger an actuating function. For example, in addition to the gesture control, an actuating element such as a contact portion which triggers the actuating function upon being touched can be provided. An actuating element such as a door handle can additionally also be used in a conventional way for manual opening of the door. Furthermore, different operator gestures can also be provided as operator actions which also serve, for example, to trigger different actuating functions.

In the case of a plurality of possible operator actions, although the operating comfort is fundamentally increased, since the operator can select between the different options as required, it is a challenge here that not all operator actions can be carried out and detected reliably in certain boundary conditions. The variety of operator actions can also seem confusing to an inexperienced operator, and some of the possible operator actions can even be unknown to the operator.

Various embodiments are based on the problem of configuring and developing the known method in such a way that the operating comfort is optimized further.

The above problem is solved by various aspects described herein.

Some embodiments proceed from the fact that the output of an operator information item to the operator which contains an indication of at least one of the predefined operator actions being carried out is caused by means of the control arrangement.

Various embodiments are intended to provide the operator with optimized assistance as to which of the predefined operator actions is advisable for the respective situation. Here, the operator information item is intended to be conveyed in a simple way, with the result that the operator is guided as intuitively as possible to the optimum operator action in the respective situation.

In detail, it is proposed that the predefined operator actions are assigned respective boundary conditions to be met, that at least one of the predefined operator actions is selected as recommended operator action by means of the control arrangement based on the assignment and the given boundary conditions, and that the indication of the operator information item is directed at the at least one recommended operator action being carried out.

Different possible embodiments of the predefined operator actions are the subject matter of some embodiments.

Further embodiments of the actuating function of the door arrangement are specified herein. It is conceivable that the actuating function can be performed both by motor and manually, and different operator actions are provided in each case to this end. The operator information item can facilitate the selection and the execution of one of these operator actions for the operator.

The boundary conditions which can be used in the case of the selection of the operator actions are indicated in various embodiments, inter alia, by way of the vehicle situation of the motor vehicle and/or the surroundings situation of the motor vehicle. In the case of the vehicle situation, safety-relevant aspects can also be taken into consideration, individual operator actions not being possible, for example, or having an excessively high energy consumption. The surroundings situation can result, for example, in a triggering area for an operator gesture not being accessible to the operator or it not being possible for it to be detected reliably by way of the sensor arrangement.

In addition, in various embodiments, in accordance with which a visual display apparatus of the door arrangement is used to output the operator information item. Here, the operator information item can highlight the recommended operator action particularly intuitively.

The operator default of various embodiments permits further personalization of the selection and the operator information item. Here, insofar as this is compatible with the boundary conditions, a preferred operator action is conveyed to the operator and, as an alternative, a further, available operator action is indicated.

A door arrangement for a motor vehicle is provided herein.

In various embodiments, the predefined operator actions are assigned respective boundary conditions to be met, that the control arrangement selects at least one of the predefined operator actions as recommended operator action based on the assignment and the given boundary conditions, and that the indication of the operator information item is directed at the at least one recommended operator action being carried out. Reference is made to all the statements in respect of the method according to the proposal.

A motor vehicle which is configured to carry out the method according to the proposal is also provided herein. Reference is made to all the statements in respect of the method according to the proposal and in respect of the door arrangement according to the proposal.

A method for operating a door arrangement of a motor vehicle with a door which can be adjusted via a door kinematic system, the door arrangement having a control arrangement for actuating a drive arrangement with at least one electric drive and a sensor arrangement for detecting operator actions, a plurality of predefined operating actions being provided to trigger an actuating function of the door arrangement, the occurrence of at least one of the predefined operator actions being monitored by means of the control arrangement on the basis of the detection via the sensor arrangement, and the drive arrangement being actuated, in a manner which is dependent on the occurrence, to provide the actuating function of the door arrangement by motor, the output of an operator information item which contains an indication to the operator of at least one of the predefined operator actions being carried out being caused by means of the control arrangement, wherein the predefined operator actions are assigned respective boundary conditions to be met, wherein at least one of the predefined operator actions is selected as recommended operator action by means of the control arrangement based on the assignment and the given boundary conditions, and wherein the indication of the operator information item is directed at the at least one recommended operator action being carried out.

In various embodiments, at least one operator gesture, a contact of a component of the door arrangement by the operator, the actuation of an actuating element of the door arrangement, a manual door movement, in particular via a gripping gap of the door, and/or the actuation via a mobile device are/is provided as predefined operator actions.

In various embodiments, the change in a locked state of a motor vehicle lock which is assigned to the door arrangement, a motorized and/or manual adjustment of the door, in particular motorized raising, motorized opening or motorized closing of the door, and/or a motorized adjustment of an actuating element are/is provided as actuating function of the door arrangement.

In various embodiments, the boundary conditions relate to the vehicle situation of the motor vehicle, in particular the presence of a crash state, the charging state of an energy store of the motor vehicle, an inclination of the motor vehicle and/or the state of components of the door arrangement.

In various embodiments, the boundary conditions relate to the surroundings situation of the motor vehicle, in particular the space which is available in the region of the door arrangement and/or the presence of obstacles in the region of the door arrangement, and, in some embodiments, wherein the surroundings situation is detected at least partially by means of the sensor arrangement.

In various embodiments, the output of the operator information item on a visual display apparatus of the door arrangement is caused by means of the control arrangement, in some embodiments, wherein the visual display apparatus is arranged on an actuating element, and/or wherein the output of the operator information item is caused on a mobile device of the operator by means of the control arrangement.

In various embodiments, the visual display apparatus has at least a first display field for identifying an execution area of an operator gesture and at least a second display field for identifying an actuating area for the operator, and, in some embodiments, wherein a combined actuation of the first display field and the second display field is used to identify a contact area for the operator.

In various embodiments, an operator default, in which at least one of the predefined operator actions is stored as preferred operator action, is provided for the predefined operator actions, and wherein, if the preferred operator action is categorized as one of the recommended operator actions, the operator information item contains an indication to carry out the preferred operator action.

In various embodiments, the operator default is determined by means of an operator input, in a manner which is dependent on an operator authorization which is assigned to the operator and/or which is dependent on the position of the door on the motor vehicle.

In various embodiments, the operator default contains, furthermore, an output default for outputting the operator information item, and, in some embodiments, wherein the output default relates to a light sequence and/or color to be output for the visual display apparatus.

Various embodiments provide a door arrangement for a motor vehicle, the door arrangement having a control arrangement for actuating a drive arrangement with at least one electric drive and a sensor arrangement for detecting operator actions, a plurality of predefined operator actions being provided to trigger an actuating function of the door arrangement, the control arrangement monitoring the occurrence of at least one of the predefined operator actions on the basis of the detection via the sensor arrangement, and actuating the drive arrangement to provide the actuating function of the door arrangement by motor in a manner which is dependent on the occurrence, the control arrangement causing the output to the operator of an operator information item which contains an indication of at least one of the predefined operator actions being carried out, wherein the predefined operator actions are assigned respective boundary conditions to be met, wherein the control arrangement selects at least one of the predefined operator actions as recommended operator action based on the assignment and the given boundary conditions, and wherein the indication of the operator information item is directed at the at least one recommended operator action being carried out.

Various embodiments provide a motor vehicle configured to carry out a method as described herein.

### BRIEF DESCRIPTION OF THE DRAWINGS

In the following text, various aspects will be explained in greater detail on the basis of a drawing which shows merely exemplary embodiments and in which:

FIG. 1 shows a motor vehicle with a door arrangement according to the proposal, and

FIG. 2 shows a diagrammatic illustration of an actuating element with a visual display apparatus for the motor vehicle according to FIG. 1.

### DETAILED DESCRIPTION

The exemplary embodiment which is shown in the figures relates to a method for operating a door arrangement 1 of a motor vehicle 2.

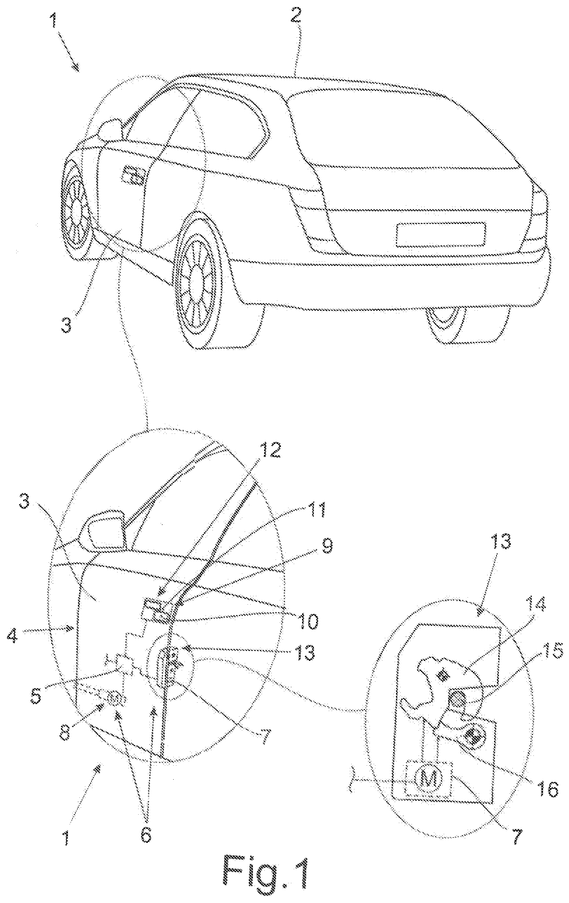

The motor vehicle 2 is equipped with a door 3 which can be adjusted via a door kinematic system. In the present case, the term “door” includes a tailgate, a trunk lid, a front hood, a motor vehicle door, in particular a side or rear door or the like; reference may be made to the introductory statements. The door 3 can be a side door of the motor vehicle 2. All the statements in this regard apply correspondingly to all other types of doors 3. All components which permit the movement of the door 3 are combined under the term “door kinematic system”. A hinge arrangement 4 is provided here by way of example, via which the door 3 can be pivoted between the closed position (shown in FIG. 1) and an open position (not shown).

The door arrangement 1 has a control arrangement 5 which, as shown in FIG. 1, can be configured as a door control unit which is assigned to the door 3 and interacts with a higher-level motor vehicle controller. The control arrangement 5 can likewise also be a constituent part of a central motor vehicle controller. The control arrangement 5 can have a discrete and/or integrated control electronics system for implementing the control tasks which arise here.

The door arrangement 1 has at least one drive arrangement 6 with at least one electric drive, the drive arrangement 6 providing at least one motorized actuating function. FIG. 1 shows two drives by way of example which are configured as a lock drive 7 and as a door drive 8.

The drive arrangement 6 is actuated by means of the control arrangement 5, in order to provide the actuating functions by motor.

The door arrangement 1 has, furthermore, a sensor arrangement 9 for detecting operator actions. The sensor arrangement 9 can detect objects in a detection area outside the motor vehicle 2, and has at least one proximity sensor. A radar sensor 10 can be provided which is configured to detect operator movements. In addition to radar sensors 10, other proximity sensors are also conceivable, for example optical sensors, capacitive sensors, ultrasonic sensors or the like. In addition, the sensor arrangement 9 can have a contact sensor 11 which is configured to detect contact by the operator and is based, for example, on a capacitive sensor. The actuation of a door handle 12 via a button can likewise be detected as operator action. Further variants of the sensor arrangement 9 are conceivable.

Overall, a plurality of predefined operator actions are provided to trigger an actuating function of the door arrangement 1. For example, in normal operation, the door 3 can be opened starting from the closed position of the door 3 both via an operator gesture detected by means of the proximity sensor, a contact of the contact sensor 11, and via a manual actuation of the door handle 12.

Here, individual examples of the predefined operator actions can trigger a sequence of the actuating function which is implemented at least in part by motor. The occurrence of at least one of the predefined operator actions is monitored by means of the control arrangement 5 on the basis of the detection via the sensor arrangement 9, and the drive arrangement 6 is actuated, in a manner which depends on the occurrence, to provide the actuating function of the door arrangement 1 by motor. The control arrangement 5 monitors, for example, whether a predetermined operator gesture is detected via the radar sensor 10. The operator gesture can comprise a predefined hand movement by the operator, such as a swiping movement of the hand. Upon detection of an operator gesture which is classified as valid, the lock drive 7 and the door drive 8 are actuated, for example, in order to open the door 3 by motor. Other predefined operator actions can also represent manual operator actions, for example manual pulling of the door handle 12 of the door 3, manual adjustment of the door 3, the actuation of a key cylinder or the like.

The output of an operator information item which contains an indication to the operator of at least one of the predefined operator actions being carried out is caused by means of the control arrangement 5. The operator information item can be a visual representation which conveys at least one of the predefined operator actions, for example by way of visual highlighting of an essential area for the operator action or a component of the door arrangement 1 to be actuated. It is intended to be possible for the operator to distinguish between the different possible operator actions on the basis of the operator information item.

It is essential that the predefined operator actions are assigned respective boundary conditions to be met, that at least one of the predefined operator actions is selected as recommended operator action by means of the control arrangement 5 based on the assignment and the given boundary conditions, and that the indication of the operator information item is directed at the at least one recommended operator action being carried out.

On the basis of the boundary conditions to be met, the control arrangement 5 produces a recommendation about which of the predefined operator actions can be carried out. Some of the predefined operator actions even cannot be readily available under the given boundary conditions, the operator information item referring the operator to an alternative operator action which is available here.

Here, in various embodiments, the operator information item can highlight merely one of the available operator actions as recommended operator action. If a plurality of operator actions are available, the operator action to be highlighted is selected, for example, on the basis of a predefined preference, in particular on the basis of the boundary conditions. It is also possible that a plurality of operator actions are available, and a plurality of the available operator actions and, in particular, all the available operator actions are highlighted on the basis of the operator information item.

As has already been addressed, different predefined operator actions are conceivable. At least one operator gesture, contact of a component of the door arrangement 1 by the operator, the actuation of an actuating element of the door arrangement 1, a manual door movement, in particular via a gripping gap of the door 3, and/or the actuation via a mobile device can be provided in various embodiments.

The operator gesture can comprise further aspects with regard to the position, walking movement, walking speed, posture or the like of the operator. In addition to the hand movement which has already been addressed, a foot movement, for example a kicking movement, can also be provided. A plurality of predetermined operator gestures can also be defined. The operator information item directed to this can indicate, for example, the area for carrying out the operator gesture. The operator information item can likewise indicate the actual operator action by way of a visual representation and, in particular, an animation, for instance by way of a specification of the direction and/or speed of the operator gesture to be performed or the like.

The contact can be a simple contact of a component of the door arrangement 1. A complex contact pattern such as the input of a code on an operating field or the like can likewise be provided. The operator information item which addresses this can visually highlight the component to be touched.

An actuation of an actuating element is understood to mean a manual action on an actuating element which is provided to this end, for example pulling the door handle 12. The operator information item which addresses this can highlight the actuating element, for example. Furthermore, the operator information item can also indicate the direction in which the actuation is to take place.

In an analogous manner with respect to this, the manual door movement to be performed can be indicated by way of highlighting of the component which is provided to this end, for example a gripping gap or the door handle 12, it also being possible for a direction of the door movement to be performed to be conveyed.

As mobile device, for example, a remote control on an electronic key, a smartphone of the operator, a smart watch of the operator or the like is provided which communicates with the control arrangement 5. The operator information item can contain, inter alia, a visual or haptic output about the fact that the triggering of the actuating function via the mobile device is recommended.

Different actuating functions are likewise conceivable. In embodiments, the change of a lock state of a motor vehicle lock 13 which is assigned to the door arrangement 1, a motorized and/or manual adjustment of the door 3, in particular motorized raising, motorized opening or motorized closing of the door 3, and/or a motorized adjustment of an actuating element can be provided as actuating function of the door arrangement 1.

As a change of the lock state, unlocking, locking and opening of the motor vehicle lock 13 can be provided, inter alia. FIG. 1 shows the motor vehicle lock 13 with a lock striker plate 14 which can be moved into locking engagement with a locking part 15 in a locked state.

Here, a locking pawl 16 is situated in locking engagement with the lock striker plate 14, and can be removed by means of the lock drive 7, in order to release the lock striker plate 14. Opening of the motor vehicle lock 13 can likewise take place manually, for example via a mechanical actuating chain (not shown) between the door handle 12 and the locking pawl 16.

Actuating functions of a central locking system, anti-theft device, child safety lock or the like can likewise be implemented in a motorized and/or manual manner.

The door drive 8 is coupled to the door 3 and serves for the motorized adjustment of the door 3. The door drive 8 can be configured as a spindle drive. Motorized opening and closing of the door 3 is implemented here via the door drive 8. The adjustment of the door 3 can likewise be performed manually by the operator via the introduction of an actuating force into the door 3.

Motorized raising of the door 3 can be provided as actuating function. Here, the lock drive 7 is configured to adjust the lock striker plate 14 into an open position starting from the closed position. As a result, for example, a gripping gap between the door 3 and the motor vehicle body is produced, which gripping gap can be reached behind by the operator for manual opening of the door 3. Motorized raising by way of the door drive 8 or a raising element which is separate from the lock striker plate 14 can likewise be brought about.

Furthermore, the actuating element can be of adjustable configuration, it being possible, for example, for the door handle 12 to be recessed in the outer skin of the door 3.

Different actuating functions of this type or else sequences of actuating functions can also be provided within the context of the method according to the proposal. For example, an operator information item with a recommended operator action with regard to the unlocking of the motor vehicle lock 13 can first of all be output. Here, the unlocking is followed by the output of an operator information item with a recommended operator action with regard to the opening of the motor vehicle lock 13 and the door 3.

Furthermore, it can be provided that the boundary conditions relate to the vehicle situation of the motor vehicle 2, in particular the presence of a crash state, the charging state of an energy store of the motor vehicle 2, an inclination of the motor vehicle 2 and/or the state of components of the door arrangement 1.

The boundary conditions relating to the vehicle situation can be forwarded by the central motor vehicle controller to the control arrangement 5, for example via a status information item. In one refinement, the control arrangement 5 can also have a sensor system for determining the vehicle situation.

In the case of a crash state, it can be taken into consideration that some of the predefined operator actions are possibly not available. In particular, one of the predefined operator actions is stored in the assignment as safest operator action, with the result that the optimum operator action is conveyed to the operator in the crash state of the motor vehicle 2. The same applies to the state of the components of the door arrangement 1. For example, there is an error state of the drive arrangement 6, with the result that a manual actuation is recommended to the operator by way of the operator information item. There can likewise be mechanical blocking of the door 3, for example as a result of freezing, as state of the door arrangement.

In the case of a low charging state of the energy store, in particular the central motor vehicle battery, an operator action can be recommended which further conserves the energy store. For example, the operator is notified of a manual actuation here. It is likewise conceivable that an output of the operator information item is performed in an energy-saving way, for instance by only a single operator action being conveyed or else an output with a decreased intensity being performed.

The inclination of the motor vehicle 2 on a slope can lead to, in particular, the motorized adjustment of the door 3 being associated with increased energy expenditure, with the result that once again an alternative operator action is recommended to this end.

Furthermore, it can be that the boundary conditions relate to the surroundings situation of the motor vehicle 2, in particular the space which is available in the region of the door arrangement 1 and/or the presence of obstacles in the region of the door arrangement 1, and, in some embodiments, that the surroundings situation is detected at least partially by means of the sensor arrangement 9.

The space which is available in the region of the door arrangement 1 can be detected via the radar sensor 10. If, for example, the motor vehicle 2 is parked in a tight space next to other motor vehicles, the performance and detection of an operator gesture can be hampered, with the result that an actuation via the contact sensor 11 is recommended to the operator, for example, by means of the operator information item.

The presence of obstacles can lead to a motorized adjustment of the door 3 being associated with a risk of collision. For safety reasons, a manual adjustment of the door 3 can be recommended here to the operator, it also being possible for an indication on the presence and, in particular, the position of the obstacle to take place.

It can be provided that the output of the operator information item is caused on a visual display apparatus 17 of the door arrangement 1 by means of the control arrangement 5, such as that the visual display apparatus 17 is arranged on an actuating element, and/or that the output of the operator information item on a mobile device of the operator is caused by means of the control arrangement 5.

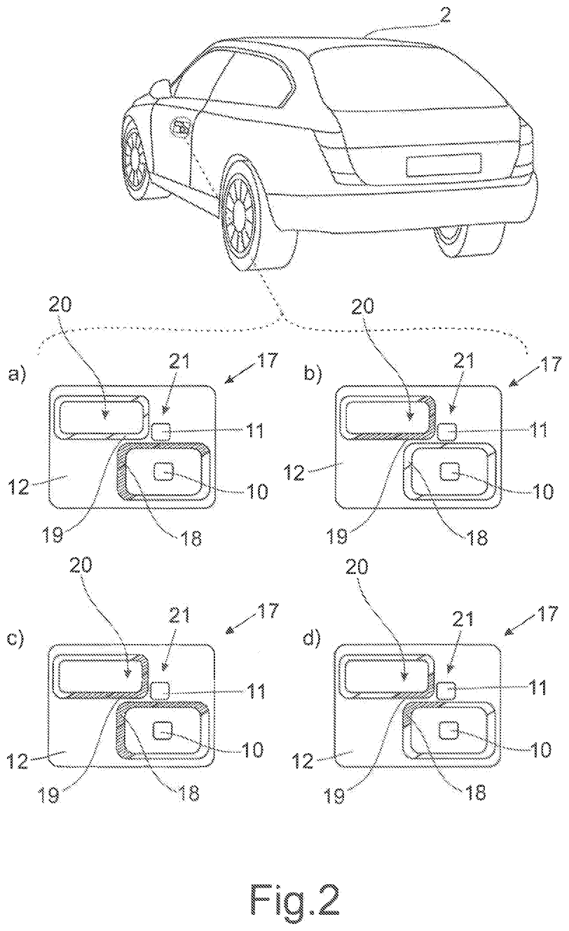

FIG. 2 shows one exemplary embodiment of the visual display apparatus in greater detail, the visual display apparatus being provided here on the door handle. The visual display apparatus can likewise be arranged in the B-pillar, can be directed onto the window of the door, or else can be arranged distributed over the door arrangement. The output on a mobile device can be provided in addition or as an alternative.

Furthermore, it can be provided that the visual display apparatus 17 has at least a first display field 18 for identifying an execution area of an operator gesture and at least a second display field 19 for identifying an actuating area 20 for the operator, and, in some embodiments that a combined actuation of the first display field and the second display field is used to identify a contact area 21 for the operator.

FIG. 2a) shows one example for an output of the operator information item with an indication of one operator gesture as recommended operator action, the first display field 18 being activated. The detection is provided via the radar sensor 10 in the region of the first display field 18. FIG. 2b) shows one example for an output of the operator information item with an indication of a manual actuation of the door handle as recommended operator action, the second display field 19 being activated. Here, the region of the second display field has, as actuating region, a grip portion of the door handle 12 which is provided for manual actuation by the operator.

In the illustration in FIG. 2c), the first display field 18 and the second display field 19 are activated, whereby an indication of the recommendation both for the operator gesture and for the manual actuation is given.

FIG. 2d) shows a combined actuation of the first display field 18 and second display field 19 for identifying a contact region 21, in which the contact sensor 11 is in turn arranged. Here, this display can differ from the display which is shown in FIG. 2c), the display fields 18, 19 being activated only in sections, for example. As an alternative or in addition, a further display field for identifying the contact region 21 can also be provided.

Furthermore, it can be provided that an operator default, in which at least one of the predefined operator actions is stored as preferred operator action, is provided for the predefined operator actions, and that, if the preferred operator action is categorized as one of the recommended operator actions, the operator information item contains an indication to carry out the preferred operator action.

Here, a check as to whether the preferred operator action is available can be carried out on the basis of the assignment of the boundary conditions. If the preferred operator action is not to be recommended under the given boundary conditions, an alternative operator action can be proposed. A plurality of operator actions can also be stored as preferred operator actions in the operator default and, in particular, a ranking order can be assigned to the preferred operator actions. For example, the operator action which is recommended under the given boundary conditions and has the highest rank in accordance with the ranking order is selected and is conveyed by way of the operator information item.

Furthermore, it can be provided that the operator default is determined by means of an operator input, in a manner which is dependent on an operator authorization which is assigned to the operator and/or which is dependent on the position of the door 3 on the motor vehicle 2.

The operator default can take place in a personalized manner via the operator input. In particular, an identification of the operator is performed, for example via the detection of an electronic key, a mobile device or the like, an adaptable operator default being stored for the respective operator.

The operator default can also be dependent on an operator authorization which indicates which operator actions the respective operator may access. For example, it is provided for unknown operators that a particularly simple operator action is recommended, whereas more complex operator actions such as operator gestures can be recommended for experienced operators which are detected in the identification operation.

A distinction can be made for the position of the door between the driver door, the passenger door, the right-hand rear door, the left-hand rear door, the front hood and/or the tailgate. Here, for example, a more complex operator action is also recommended for the driver door than for the passenger door.

Furthermore, it can be provided that the operator default contains, furthermore, an output default for outputting the operator information item, and in some embodiments that the output default relates to a light sequence and/or color to be output for the visual display apparatus 17.

Accordingly, further personalization of the output of the operator information item takes place via the operator default. The operator can set, for example, that recommended operator defaults are also indicated via different light sequences and/or colors. A light sequence is to be understood to mean a temporal sequence of visual outputs.

Moreover, a door arrangement 1 for a motor vehicle 2 is provided, the door arrangement having a control arrangement for actuating a drive arrangement with at least one electric drive and a sensor arrangement for detecting operator actions, a plurality of predefined operator actions being provided to trigger an actuating function of the door arrangement, the control arrangement monitoring the occurrence of at least one of the predefined operator actions on the basis of the detection via the sensor arrangement, and actuating the drive arrangement to provide the actuating function of the door arrangement by motor in a manner which is dependent on the occurrence, the control arrangement causing the output to the operator of an operator information item which contains an indication of at least one of the predefined operator actions being carried out.

It can be that the predefined operator actions are assigned respective boundary conditions to be met, that the control arrangement 5 selects at least one of the predefined operator actions as recommended operator action based on the assignment and the given boundary conditions, and that the indication of the operator information item is directed at the at least one recommended operator action being carried out. Reference is made to all the statements in respect of the method according to the proposal.

Moreover, a motor vehicle 2 configured to carry out a method according to the proposal is provided. The motor vehicle 2 has, in particular, the door arrangement 1 according to the proposal and a door 3 which is assigned to the door arrangement 1.

1. A method for operating a door arrangement of a motor vehicle with a door which can be adjusted via a door kinematic system, the door arrangement having comprising a control arrangement for actuating a drive arrangement with at least one electric drive and a sensor arrangement for detecting operator actions, a plurality of predefined operating actions being provided to trigger an actuating function of the door arrangement,
the occurrence of at least one of the predefined operator actions being monitored by means of the control arrangement on the basis of the detection via the sensor arrangement, and the drive arrangement being actuated, in a manner which is dependent on the occurrence, to provide the actuating function of the door arrangement by motor, the output of an operator information item which contains an indication to the operator of at least one of the predefined operator actions being carried out being caused by the control arrangement,
wherein the predefined operator actions are assigned respective boundary conditions to be met, wherein at least one of the predefined operator actions is selected as recommended operator action by means of the control arrangement based on the assignment and the given boundary conditions, and wherein the indication of the operator information item is directed at the at least one recommended operator action being carried out

2. The method as claimed in claim 1, wherein at least one operator gesture, a contact of a component of the door arrangement by the operator, the actuation of an actuating element of the door arrangement, a manual door movement, and/or the actuation via a mobile device are/is provided as predefined operator actions.

3. The method as claimed in claim 1, wherein the change in a locked state of a motor vehicle lock which is assigned to the door arrangement, a motorized and/or manual adjustment of the door, and/or a motorized adjustment of an actuating element are/is provided as actuating function of the door arrangement.

4. The method as claimed in claim 1, wherein the boundary conditions relate to the vehicle situation of the motor vehicle.

5. The method as claimed in claim 1, wherein the boundary conditions relate to the surroundings situation of the motor vehicle.

6. The method as claimed in claim 1, wherein the output of the operator information item on a visual display apparatus of the door arrangement is caused by means of the control arrangement, and/or wherein the output of the operator information item is caused on a mobile device of the operator by the control arrangement.

7. The method as claimed in claim 6, wherein the visual display apparatus comprises at least a first display field for identifying an execution area of an operator gesture and at least a second display field for identifying an actuating area for the operator.

8. The method as claimed in claim 1, wherein an operator default, in which at least one of the predefined operator actions is stored as preferred operator action, is provided for the predefined operator actions, and wherein, if the preferred operator action is categorized as one of the recommended operator actions, the operator information item contains an indication to carry out the preferred operator action.

9. The method as claimed in claim 8, wherein the operator default is determined by an operator input, in a manner which is dependent on an operator authorization which is assigned to the operator and/or which is dependent on the position of the door on the motor vehicle.

10. The method as claimed in claim 8, wherein the operator default contains, furthermore, an output default for outputting the operator information item.

11. A door arrangement for a motor vehicle, the door arrangement comprising a control arrangement for actuating a drive arrangement with at least one electric drive and a sensor arrangement for detecting operator actions, a plurality of predefined operator actions being provided to trigger an actuating function of the door arrangement,
the control arrangement monitoring the occurrence of at least one of the predefined operator actions on the basis of the detection via the sensor arrangement, and actuating the drive arrangement to provide the actuating function of the door arrangement by motor in a manner which is dependent on the occurrence, the control arrangement causing the output to the operator of an operator information item which contains an indication of at least one of the predefined operator actions being carried out,
wherein the predefined operator actions are assigned respective boundary conditions to be met, wherein the control arrangement selects at least one of the predefined operator actions as recommended operator action based on the assignment and the given boundary conditions, and wherein the indication of the operator information item is directed at the at least one recommended operator action being carried out.

12. A motor vehicle configured to carry out a method as claimed in claim 1.

13. The method as claimed in claim 3, wherein the motorized adjustment of the door comprises motorized raising, motorized opening or motorized closing of the door.

14. The method as claimed in claim 4, wherein the vehicle situation comprises the presence of a crash state, the charging state of an energy store of the motor vehicle, an inclination of the motor vehicle or the state of components of the door arrangement.

15. The method as claimed in claim 5, wherein the surroundings situation of the motor vehicle comprise the space which is available in the region of the door arrangement and/or the presence of obstacles in the region of the door arrangement,

16. The method as claimed in claim 5, wherein the surroundings situation is detected at least partially by the sensor arrangement.

17. The method as claimed in claim 6, wherein the visual display apparatus is arranged on an actuating element.

18. The method as claimed in claim 7, wherein a combined actuation of the first display field and the second display field is used to identify a contact area for the operator.

19. The method as claimed in claim 10, wherein the output default relates to a light sequence and/or color to be output for the visual display apparatus.
